(19) United States
(12) Patent Application Publication
(10) Pub. No.: US 2026/0225605 A1
(43) Pub. Date: Aug. 6, 2026

(54) RANGE DETERMINATION FOR A MOTOR VEHICLE AS A FUNCTION OF A SUSTAINABILITY CHARACTERISTIC

(71) Applicant: Volkswagen Aktiengesellschaft, Wolfsburg (DE)

(72) Inventor: Michael BIPPES, Wolfsburg (DE)

(73) Assignee: Volkswagen Aktiengesellschaft, Wolfsburg (DE)

(21) Appl. No.: 19/531,348

(22) Filed: Feb. 5, 2026

(30) Foreign Application Priority Data
Feb. 5, 2025 (DE) 10 2025 104 138.5

(51) Int. Cl. B60W 50/14; G01C 21/34; G01C 21/36

(52) U.S. Cl. CPC B60W 50/14; G01C 21/3469; G01C 21/3679; B60W 2050/146; B60W 2530/209

(57) ABSTRACT

A method for operating a motor vehicle that includes an operating fuel reservoir is characterized in that a filling of the operating fuel reservoir with a quantity of at least one operating fuel is determined. A value for a sustainability characteristic is assigned to the operating fuel. A range of the motor vehicle for operation with the quantity of the operating fuel is determined as a function of the value for the sustainability characteristic.

This nonprovisional application claims priority under 35 U.S.C. § 119(a) to German Patent Application No. 10 2025 104 138.5, which was filed in Germany on February 5, 2025, and which is herein incorporated by reference.

### BACKGROUND OF THE INVENTION

### Field of the Invention

The invention relates to a method for operating a motor vehicle.

### Description of the Background Art

The sustainability with which a motor vehicle can be operated depends primarily on the sustainability of the energy source used for operation of the motor vehicle. For example, motor vehicles that can be driven via combustion motors can be operated with fossil fuels produced from petroleum or natural gas. The sustainability of fossil fuels is considered poorly sustainable, however, in particular on account of the carbon dioxide (CO₂) emitted directly by a combustion of these fuels. On the other hand, it is possible to operate motor vehicles having combustion motors with regeneratively produced fuels, so-called e-fuels, which have been synthetically manufactured from water and carbon dioxide using electric power. If the electric power required for this purpose comes from regenerative sources, for example through the use of wind power and photovoltaics, a motor vehicle operated via such a regenerative fuel can be operated with low CO₂ emissions or even in a CO₂-neutral manner, and thus sustainably. Fuels that are produced and extracted from renewable raw materials such as plants are another example of sustainable fuels. These plants bind CO₂ from the atmosphere during growth, and thus can have substantially better sustainability as compared with fossil fuels.

Similar considerations also arise for operation of electric vehicles, depending on the sources from which the electric power originates for driving these motor vehicles.

Limitations on nonsustainable or poorly sustainable operation of motor vehicles are widely discussed. These discussion also include possible restrictions in urban areas on operation of motor vehicles having combustion motors operated with fossil fuels.

US 6,494,190 B1 discloses an internal combustion engine that can be operated via a liquid and a gaseous fuel, wherein these two fuel types are stored in the same tank and are supplied through the same supply apparatus to a combustion motor of the internal combustion engine.

### SUMMARY OF THE INVENTION

It is therefore the object of the present invention is to provide a method for operating a motor vehicle relatively sustainably.

A method for operating a motor vehicle that includes at least one operating fuel reservoir is characterized according to the invention in that a filling of the operating fuel reservoir with a quantity of at least one operating fuel is determined, wherein a value for a sustainability characteristic is assigned to the operating fuel, and a range of the motor vehicle for operation with the quantity of the operating fuel is determined as a function of the value for the sustainability characteristic.

According to the invention, provision can be made accordingly to determine a range for the motor vehicle as a function of the sustainability characteristic of the at least one operating fuel with which the operating fuel reservoir is filled and with which an operation of the motor vehicle is therefore possible, which range can differ from a real range that is physically possible by operation of the motor vehicle with the available operating fuel. The range determined as a function of the sustainability characteristic can in this case also be zero, for example, whereby there can be a possibility to, e.g., automatically prevent or to limit an operation of the vehicle, for example with regard to a maximum obtainable power, even though an (unlimited) operation of the motor vehicle would be physically possible.

Against this background, provision can be made in accordance with an example of a method according to the invention that a limit value is defined for the sustainability characteristic, wherein a range for the quantity of the operating fuel is used when the determined value is better than the limit value. Whether a better value is larger or smaller than a limit value compared therewith depends, in particular, on the type or the definition of the sustainability characteristic.

Preferably, the sustainability characteristic can be defined as a global warming potential, in particular relative to a time period of 100 years, or as a CO₂ equivalent or else as a CO₂ reduction quota (relative to a defined reference operating fuel, for example an arbitrary fossil fuel (e.g., gasoline or diesel or natural gas). The sustainability characteristic can also be defined, however, as a value that relates to a production standard, for example. Such a production standard can include defined labor conditions and/or requirements for cultivation of plants and/or algae for producing an operating fuel. A requirement for cultivation of plants and/or algae can include a requirement that governs crop rotation and/or the type and/or quantity of a fertilizer used and/or the water and/or space needs, for example. Furthermore, such a production standard for electricity can include defined labor conditions and/or requirements for a site, the way in which the power generator is connected to a (distribution) grid and/or to a processing site for electricity, for example a water electrolysis plant. For example, requirements can apply to wind turbines that ensure that birdlife is harmed as little as possible by the installation thereof. In addition, requirements that describe environmental pollution with electromagnetic fields can apply in the case of connection to a grid or to a processing site for electricity.

In accordance with an example of a method according to the invention, provision can be made that the limit value is determined as a function of a location of the motor vehicle. The limit value can therefore also change as a result of a change in the motor vehicle’s location. Accordingly, provision can be made that a limit value is applied through which a range or even the operation of the motor vehicle per se can be limited, if applicable, in certain places, for example urban areas, while this does not apply in other places or applies with a different limit value. In addition or alternatively thereto, provision can be made that the limit value is assigned to the motor vehicle by personnel (i.e., based on direct interaction by a person).

A use of a determined range preferably can include communicating such a range to a person via an arbitrary HMI (human-machine interface) and for this purpose to display it on a display of the motor vehicle or to output it via a different type of output device, for example. A display of a range can be accomplished, for example, as an appropriately dimensioned circle in a map of a navigation system of the motor vehicle and/or as a number and/or as a column or bar of a (column or bar) chart. Furthermore, a use of a determined range can reside in automatically allowing an operation of the motor vehicle only within the limits of the determined range. In addition, a use of a determined range can include that a route calculation is automatically created or adjusted as a function thereof. The route calculation preferably can then be created or adjusted in such a manner that the determined range allows a furthest possible travel in at least one restriction zone in which the limit value applies. In addition or alternatively, provision can furthermore be made that the adjustment of the route calculation encompasses an inclusion of a supply station that provides an operating fuel to which a value for the sustainability characteristic has been assigned that is better than the limit value.

Since an operating fuel reservoir of a motor vehicle usually is not completely emptied when an operating fuel is refilled, it can happen that the reservoir contains at least a quantity of a second operating fuel in addition to a quantity of a first operating fuel, and potentially also additional quantities of further operating fuel, which differ with regard to a respective assigned value for the sustainability characteristic. Against this background, it can be advantageous that a method according to the invention can carry out characterizing procedures for at least one, preferably for multiple, and especially preferably for all of these operating fuel contained in the (same) operating fuel reservoir. Accordingly, provision can be made, at a minimum, that a filling of the (same) operating fuel reservoir with one quantity each of at least two operating fuel (i.e., at least a first and a second operating fuel) is determined, wherein a (first, second) value for the sustainability characteristic is assigned to each of the operating fuel, and a range of the motor vehicle for an operation with the respective quantity of the (first or second) operating fuel is determined as a function of the sustainability characteristic. If the operating fuel have different values for the sustainability characteristic, this can result in different ranges being determined for the motor vehicle as a function of the sustainability characteristic. These different determined ranges can be used in total or separately. In particular, provision can be made to use determined ranges in total for quantities of operating fuel whose values are better than a limit value, whereas such determined ranges for quantities of operating fuel for which this is not the case are used separately.

If an intended trip route encompasses multiple restriction zones that differ with regard to the limit values applying therein, a route calculation preferably can be created or adjusted in such a manner that the multiple restriction zones can be traveled as completely as possible with the quantities of the different operating fuel and the associated values for the sustainability characteristic.

Since multiple operating fuel taken into account within the scope of a method according to the invention can be of different types, it can also be advantageous to store them in different operating fuel reservoirs and to carry out a method according to the invention accordingly.

In accordance with a preferred embodiment of the method according to the invention, provision can be made that the value for the sustainability characteristic is modified in order to determine a modified range of the motor vehicle for operation with the operating fuel. This can be accomplished, for example, by the means that a defined sustainability certificate is assigned to the value for the sustainability characteristic. For this purpose, it can be possible to acquire a corresponding sustainability certificate, by which means the value for the sustainability characteristic can be improved. An acquisition of a sustainability certificate can include a purchase via payment. A sustainability certificate can be an official digital certification with a credit balance regarding the sustainability characteristic, wherein this credit balance can be assigned to the operating fuel in order to improve its value for the sustainability characteristic.

Provision can also be made that a modification of the value for the sustainability characteristic of at least one operating fuel is stored as a sustainability difference. Consequently, provision can be made, for example, to improve the value for the sustainability characteristic, and thus also the range achievable with the associated operating fuel, in that the corresponding sustainability difference is entered as a negative. Such a negative entry can lead to a reduction in a previously accumulated sustainability credit balance or to sustainability deficits that are offset subsequently, for example in that the operating fuel reservoir is filled with a different operating fuel that has a better value for the sustainability characteristic and whose value is worsened to offset the sustainability deficit.

Furthermore, provision can be made that the value for the sustainability characteristic is modified for only one portion or for multiple portions (in which case, in different ways (which is to say improved or worsened) and/or to different extents) of the quantity of at least one operating fuel. For example, provision can be made to improve the value for the sustainability characteristic of only a first portion of the operating fuel sized such that the value for the first portion is better than a limit value and a sufficiently long range can be achieved with this first portion to be able to travel a restriction zone in which this limit value applies, for example by an assignment of a sustainability certificate or by a proportionately corresponding modification of the value of a second portion. Consequently, provision can also be made to mathematically divide an operating fuel into at least two portions, of which one portion receives an improved value and the other a worsened value for the sustainability characteristic.

If the operating fuel reservoir contains at least two operating fuel, provision can further be made that a difference between the determined value and the modified value of one of the quantities of operating fuel is assigned to the other quantity of operating fuel so that an improvement in the value for the sustainability characteristic of one operating fuel consequently can be mathematically obtained through a proportionately corresponding worsening of the value of the other operating fuel.

An operating fuel used or taken into account within the scope of a method according to the invention can be, preferably, a fuel. The fuel can be liquid or gaseous, in particular. A fuel in this context is a combustible material that is intended and designed for its chemical energy to be convertible into mechanical energy in an internal combustion engine. The operating fuel reservoir can then be a fuel tank. An operating fuel furthermore can also be a different combustible material, for example a combustible material for operating a fuel cell. The operating fuel reservoir can then be a combustible material/fuel tank. An operating fuel can also be electric power that can be stored by filling an operating fuel reservoir in the form of an electrochemical energy storage device, in particular a battery, preferably a traction battery, of the motor vehicle. These operating fuels can be provided for the purpose of making possible a propulsion of the motor vehicle, in particular, and accordingly represent energy for the operation of at least one drive motor (combustion motor or electric traction motor) of the motor vehicle.

Furthermore, it is possible that the operating fuel is an arbitrary operating consumable, i.e., a material that is necessary for operation of the motor vehicle and in this case is subject to consumption that influences a range of the motor vehicle. Such an operating consumable can be, for example, a reducing agent that is introduced in a metered fashion into exhaust gas emitted by a combustion motor of the motor vehicle in order to be active within the framework of a reduction of at least one pollutant component (for example, nitrogen oxides) of the exhaust gas. Urea could be one example of a reducing agent. Hydrogen could be another example of a reducing agent. Ammonia could be another example of a reducing agent. It is also possible that a reducing agent could be natural gas, methane, gasoline, diesel, kerosene, methanol, or ethanol.

A determination of a quantity of an operating fuel with which the operating fuel reservoir is filled can be accomplished via a suitable internal sensor (i.e., constituting a component of the motor vehicle) or an external sensor (i.e., not constituting a component of the motor vehicle), for example a flow sensor or an electric meter or even on the basis of a changing measured value of a device for determining a fill level of the operating fuel reservoir. In the case of a determination via an external sensor, a suitable data transmission can take place from the external sensor to a control device that controls the execution of a method according to the invention, wherein this data transmission can take place automatically, preferably wirelessly, or else by personnel, for example through a manual entry.

An assignment of a sustainability characteristic to a quantity of an operating fuel can likewise be accomplished internally or externally. For this purpose, a characteristic, in particular a chemical or physical characteristic, of a liquid or gaseous fuel or operating consumable can be identified via an internal or external sensor, and, based thereon, the sustainability characteristic previously assigned to this chemical or physical characteristic can, for example, be assigned to the operating fuel. Such a sensor can be an optical sensor, an acoustic sensor, or a sensor for determining a dielectric constant, for example. The chemical or physical characteristic to be identified can, in particular, also be based on the fact that an appropriate additive (“chemical or physical marker”) is added to the fuel or operating consumable in this case. One example of an additive is a dye whose color differs from a basic color of the operating fuel used and that can be detected via an optical sensor. It is understood that a dye is an example of a material with an optical characteristic in the visible range. Of course, dyes with characteristics outside the visible range can also be used. Accordingly, the optical characteristic of the material outside the visible range is different from the optical characteristic of the operating fuel.

A determination of at least a quantity and/or a sustainability characteristic of an operating fuel can also be realized by taking into account a digital representation of the operating fuel. In the same way, a data transmission regarding a quantity and/or a sustainability characteristic of an operating fuel can be accomplished with a data set in the form of a digital representation. Such a digital representation can also be referred to as a digital twin. For this purpose, characteristics of the operating fuel, in particular with regard to the sustainability characteristic, can be determined (in particular mathematically) during production thereof and assigned to the operating fuel. During a filling of the operating fuel reservoir, this information, which contains the digital representation of the operating fuel including the quantity and/or the sustainability characteristic, can then be exchanged between an external supply station and the control device. Additional characteristics of the operating fuel can also be communicated. Provision can be made that the supply station first reports the filling process of the operating fuel to an external switching and/or processing center, and this external switching and/or processing center then transmits the data to the control device of the motor vehicle.

A quantity of an operating fuel preferably can be determined as an energy quantity. A determination as a function of a volume and/or a mass and/or a pressure and/or temperature level and/or a density can also be implemented advantageously. In this case, provision can be made to convert an applicable value into a corresponding value for an energy quantity.

A motor vehicle that is or can be operated according to the invention can, in particular, be a wheeled, non-railborne motor vehicle (preferably a passenger car or a truck).

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a motor vehicle that can be operated according to the invention in accordance with an example, and

FIG. 2 shows a motor vehicle that can be operated according to the invention in accordance with an example.

### DETAILED DESCRIPTION

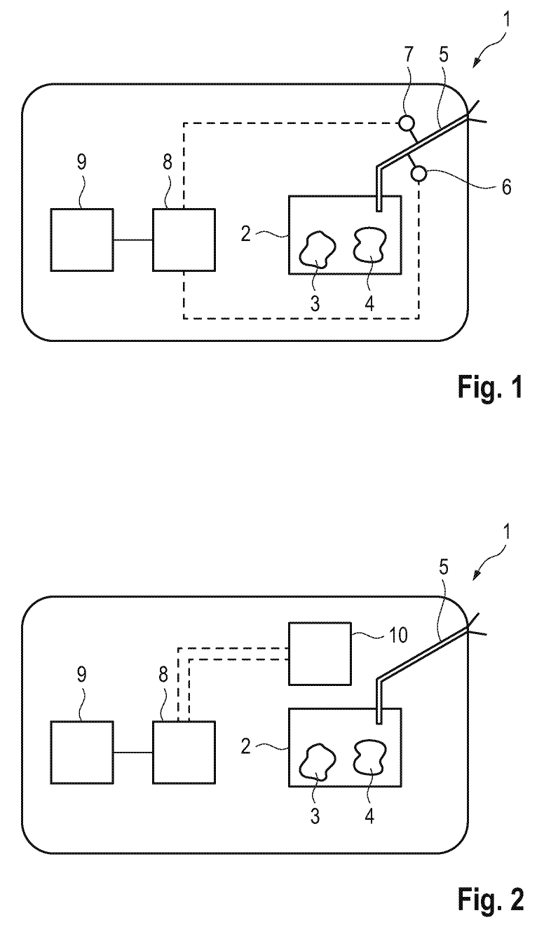

FIG. 1 shows a motor vehicle 1 that can be operated according to the invention or that can be used within the framework of a method according to the invention and that has a range determination system. This range determination system includes an operating fuel reservoir 2, in which a quantity of a first operating fuel 3 and a quantity of a second operating fuel 4 are held. A filling of the operating fuel reservoir 2 is accomplished through a filling line 5 having a connection that a complementary connection of an external operating fuel source can be connected to. During a filling of the operating fuel reservoir 2, the quantity of the supplied operating fuel 3, 4 can be determined via a first acquisition unit 6 in the form of a flow sensor. In addition, a sustainability characteristic of this operating fuel 3, 4 can be determined via a second acquisition unit 7, which can be designed in the form of an optical sensor, for example. The data determined by the acquisition units 6, 7 are transmitted to a control device 8, which evaluates this data. In this process, a range of the motor vehicle 1 is determined for the quantities of different operating fuels 3, 4 held in the operating fuel reservoir 2, in each case for operation with these operating fuels 3, 4 as a function of the respective value for the sustainability characteristic. This result of determination is communicated or displayed via an HMI 9, which has a display, for example.

The range determination system of the motor vehicle 1 shown in FIG. 2 differs from the one in accordance with FIG. 1 in that no internal acquisition units 6, 7 are provided, but instead the data determined by external acquisition units are transmitted wirelessly to an applicable receiving unit 10 using, e.g., an arbitrary wireless communication protocol. Otherwise, the mode of operation of the range determination system of the motor vehicle shown in FIG. 2 corresponds to that of FIG. 1.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating a motor vehicle that comprises an operating fuel reservoir, the method comprising:
determining a filling of the operating fuel reservoir with a quantity of at least one operating fuel;
assigning a value for a sustainability characteristic to the operating fuel; and
determining a range of the motor vehicle for operation with the quantity of the operating fuel as a function of the value for the sustainability characteristic.

2. The method according to claim 1, wherein a limit value is defined for the sustainability characteristic, and wherein a range for the quantity of the operating fuel is used when the determined value is better than the limit value.

3. The method according to claim 2, wherein the limit value is determined as a function of a location of the motor vehicle or is assigned to the motor vehicle by personnel.

4. The method according to claim 1, wherein a use of the range is or includes a communication of the range via an HMI and/or a limiting of an operation of the motor vehicle and/or a creation or adjustment of a route calculation.

5. The method according to claim 4, wherein the route calculation is adjusted in such a manner that the determined range allows a furthest possible travel in a restriction zone in which the limit value applies.

6. The method according to claim 4, wherein the adjustment of the route calculation encompasses an inclusion of a supply station that provides an operating fuel to which a value for the sustainability characteristic has been assigned that is better than the limit value.

7. The method according to claim 1, wherein the value for the sustainability characteristic of the operating fuel is modified, wherein a sustainability certificate is assigned to this value or the modification is stored as a sustainability difference.

8. The method according to claim 7, wherein the value for the sustainability characteristic is modified for only one portion, or is modified differently for multiple portions, of the quantity of the operating fuel.

9. The method according to claim 1, wherein a filling of the operating fuel reservoir or multiple operating fuel reservoirs with one quantity each of at least two operating fuels is determined, wherein a value for the sustainability characteristic is assigned to each of the operating fuels, and a range of the motor vehicle for an operation with the respective quantity of each of the operating fuels is determined as a function of the sustainability characteristic.

10. The method according to claim 9, wherein the values for the sustainability characteristic of the at least two operating fuels are modified, wherein a difference between the determined value and the modified value of one of the operating fuels is assigned to the other operating fuel.

11. The method according to claim 1, wherein the at least one operating fuel is a fuel, an operating consumable, or electric power.

12. The method according to claim 1, wherein the sustainability characteristic is defined as a CO₂ equivalent or as a value that relates to a production standard.
